(19) United States
(12) Patent Application Publication
(10) Pub. No.: US 2019/0053489 A1
(43) Pub. Date: Feb. 21, 2019

(54) ANTIMICROBIAL COMPOSITION

(71) Applicants: NATIONAL UNIVERSITY CORPORATION TOKYO MEDICAL AND DENTAL UNIVERSITY, Tokyo (JP); WAKO FILTER TECHNOLOGY Co., LTD., Tokyo (JP)

(72) Inventors: Yasunari MIYAZAKI, Bunkyo-ku, Tokyo (JP); Hiroki KAGESHIMA, Nagareyama-shi, Chiba (JP); Akira SAITO, Toride-shi, Ibaraki (JP)

(21) Appl. No.: 16/075,908

(22) PCT Filed: Feb. 6, 2017
(86) PCT No.: PCT/JP2017/004157

§ 371 Date: Aug. 6, 2018

(30) Foreign Application Priority Data
Feb. 8, 2016 (JP) 2016-022099

(51) Int. Cl. A01N 43/16; A01N 25/10

(52) U.S. Cl. CPC A01N 43/16; A01N 25/10

(57) ABSTRACT

A novel antimicrobial composition useful against infectious microbes which cause respiratory infectious diseases employs highly safe natural food additives and comprises a complex of lysozyme and chitosan bound to each other which has an antimicrobial property against an infectious microbe which causes respiratory infectious diseases.

### TECHNICAL FIELD

The present invention relates to an antimicrobial composition with an antimicrobial property against an infectious microbe which causes respiratory infectious diseases.

### BACKGROUND ART

Nontuberculous mycobacteria such as MRSA, pseudomonas aeruginosa, and pulmonary MAC (Mycobacterium avium complex) are infectious microbes which cause respiratory infectious diseases. These infectious diseases become intractable and thus are seen problematic.

Here, a possible preventive and/or therapeutic agent for respiratory infectious diseases is one containing lactic acid bacteria which belongs to Lactobacillus acidophilus as an active ingredient with an action against respiratory infectious diseases, as shown in Patent Literature 1.

However, Patent Literature 1 only shows a proliferation suppression action against an influenza virus (specifically, mouse influenza virus PR8 [A/PR/8/34 (H1N1)]) and does not at all show a proliferation suppression action against MRSA, pseudomonas aeruginosa, or pulmonary MAC.

### CITATION LIST

### Patent Literatures

Patent Literature 1: Japanese Patent Application Publication No. 2012-241009

### SUMMARY OF INVENTION

### Problems to be Solved by the Invention

On the other hand, the present inventors have been making studies on antimicrobial properties against various microbes by using a complex of lysozyme and chitosan, which are highly safe natural food additives. The present inventors have found during the studies that the complex of lysozyme and chitosan bound to each other exhibits an antimicrobial property against an infectious microbe which causes respiratory infectious diseases.

### Means for Solution of the Problems

To be more specific, an antimicrobial composition according to the present invention comprises a complex of lysozyme and chitosan bound to each other and has an antimicrobial property against an infectious microbe which causes respiratory infectious diseases.

The antimicrobial property described above includes a proliferation suppression action against MRSA, a proliferation suppression action against pseudomonas aeruginosa, or a proliferation suppression action against nontuberculous mycobacteria. To be more specific, the antimicrobial composition contains an MRSA proliferation suppression composition, a pseudomonas aeruginosa proliferation suppression composition, or a nontuberculous mycobacteria proliferation suppression composition. The effects of this antimicrobial composition are described later.

If the antimicrobial property is the proliferation suppression action against MRSA, the concentration of the complex is desirably 0.001% by mass or more. In addition, if the antimicrobial property is the proliferation suppression action against pseudomonas aeruginosa, the concentration of the complex is desirably 0.01% by mass or more.

The antimicrobial composition is preferably mixed with a liquid such as water for injection, isotonic sodium chloride solution, Ringer's solution, purified water, or distilled water to produce a cleaning liquid. The cleaning liquid thus produced can be used for a nebulizer.

### Advantageous Effects of Invention

The present invention has an effect of suppressing the proliferation of an infectious microbe which causes respiratory infectious diseases. Thus, the present invention makes it possible to improve symptoms of respiratory infectious diseases, to cure respiratory infectious diseases, and to prevent infection thereof. Besides, lysozyme is widely used as a highly safe natural food additive. An antimicrobial composition which employs the complex of this lysozyme and chitosan makes it possible to relieve patients who use the antimicrobial composition and to reduce their stress.

### BRIEF DESCRIPTION OF DRAWINGS

FIG. 1 is a diagram illustrating a proliferation suppression effect against MRSA in a diluted medium for a lysozyme-chitosan complex, lysozyme alone, chitosan alone, and a mixture of lysozyme and chitosan.

FIG. 2 is a diagram illustrating a proliferation suppression effect against pseudomonas aeruginosa in a diluted medium for a lysozyme-chitosan complex, lysozyme alone, chitosan alone, and a mixture of lysozyme and chitosan.

FIG. 3 is a diagram illustrating a proliferation suppression effect against pulmonary MAC for a lysozyme-chitosan complex, classified by concentration.

FIG. 4 is a diagram illustrating a proliferation suppression effect against pulmonary MAC in a diluted medium for a lysozyme-chitosan complex, lysozyme alone, chitosan alone, and a mixture of lysozyme and chitosan.

FIG. 5 is a diagram illustrating a proliferation suppression effect against pulmonary MAC in a test medium sample further added with 10 mM of phosphate buffer (pH 7.0) for a lysozyme-chitosan complex, lysozyme alone, chitosan alone, and a mixture of lysozyme and chitosan.

FIG. 6 provides diagrams illustrating results of heat resistance evaluation test for a lysozyme-chitosan complex, lysozyme alone, and a mixture of lysozyme and chitosan.

FIG. 7 is a diagram illustrating a proliferation suppression effect against MRSA in a standard medium for a lysozyme-chitosan complex, lysozyme alone, chitosan alone, and a mixture of lysozyme and chitosan.

FIG. 8 is a diagram illustrating a ratio of the number of MRSA colonies produced to a control in a standard medium for a lysozyme-chitosan complex, classified by concentration.

FIG. 9 is a diagram illustrating a proliferation suppression effect against pseudomonas aeruginosa (NBRC 13275) in a standard medium for a lysozyme-chitosan complex, lysozyme alone, chitosan alone, and a mixture of lysozyme and chitosan.

FIG. 10 is a diagram illustrating a proliferation suppression effect against pseudomonas aeruginosa (PAO 1) in a standard medium for a lysozyme-chitosan complex, lysozyme alone, chitosan alone, and a mixture of lysozyme and chitosan.

FIG. 11 is a diagram illustrating a ratio of the number of pseudomonas aeruginosa (NBRC 13275) colonies produced to a control in a standard medium for a lysozyme-chitosan complex, classified by concentration.

FIG. 12 is a diagram illustrating a result of an MRSA-resistant microbe acquisition protocol for a lysozyme-chitosan complex.

FIG. 13 illustrates images obtained with a scanning electron microscope, depicting morphological change of MRSA.

FIG. 14 illustrates images obtained with a transmission electron microscope, depicting morphological change of MRSA.

FIG. 15 illustrates images obtained with a transmission electron microscope, depicting morphological change of pseudomonas aeruginosa.

FIG. 16 illustrates images obtained with a scanning electron microscope and depicting morphological change of MRSA in the case where a lysozyme-chitosan complex, lysozyme alone, chitosan alone, and a mixture of lysozyme and chitosan are added.

FIG. 17 illustrates images obtained with a scanning electron microscope and depicting morphological change of pseudomonas aeruginosa in the case where a lysozyme-chitosan complex, lysozyme alone, chitosan alone, and a mixture of lysozyme and chitosan are added.

FIG. 18 illustrates images obtained with a scanning electron microscope and depicting morphological change of MRSA in the case where DNase I treatment is carried out on MRSA added with a lysozyme-chitosan complex.

FIG. 19 illustrates images obtained with a scanning electron microscope and depicting morphological change of pseudomonas aeruginosa in the case where DNase I treatment is carried out on MRSA added with a lysozyme-chitosan complex.

### DESCRIPTION OF EMBODIMENTS

Hereinafter, a description is provided for an embodiment of the present invention.

The antimicrobial composition according to the present embodiment contains a complex of lysozyme and chitosan (being water soluble and having a molecular weight of 25000 Da or less) bound to each other. Note that the present embodiment employs a chitosan having a molecular weight of 14000 Da.

The lysozyme-chitosan complex of the present embodiment can be produced by binding lysozyme and chitosan to each other through the Maillard reaction. If lysozyme and chitosan are bound to each other through the Maillard reaction, all or almost all of the antigen structures in the lysozyme are masked, making it unlikely to cause an allergy even when the lysozyme-chitosan complex is ingested.

A specific production method is as follows.

Lysozyme and chitosan in an amount with a mass ratio, lysozyme/chitosan, of more preferably 60/40 to 40/60 are mixed and dissolved in water to prepare an aqueous solution with the total content of lysozyme and chitosan therein being 5 to 30% by mass. The obtained aqueous solution is freeze dried for powderization. The obtained powder is subjected to the Maillard reaction under the conditions of a temperature of 50 to 80° C. or more preferably 55 to 65° C. and a relative humidity of 50 to 80% or more preferably 60 to 70% for 2 to 20 days or more preferably 7 to 14 days. In this way, it is possible to produce the lysozyme-chitosan complex of the present invention.

Regarding the production of the lysozyme-chitosan complex of the present embodiment, it is possible to check the production of the polymer material being a protein-chitosan complex by use of a plate subjected to staining process, where the plate is obtained by SDS (Sodium dodecyl sulfate-polyacrylamide) electrophoresis.

Next, a description is provided for the antimicrobial composition of the present embodiment.

The antimicrobial composition of the present embodiment is formed by mixing the lysozyme-chitosan complex with a liquid such as water for injection, isotonic sodium chloride solution, Ringer's solution, purified water, or distilled water, and contains the lysozyme-chitosan complex at preferably 0.001% by mass or more in order to more retain its antimicrobial power. Note that an allergy could be caused when curing a respiratory infectious disease if the concentration of the lysozyme-chitosan complex is excessively high. Here, the upper limit value of the concentration of the lysozyme-chitosan complex is 1.0% by mass.

For example, if the antimicrobial composition is used as an MRSA proliferation suppression composition, the concentration of the lysozyme-chitosan complex is preferably 0.001% by mass or more. In addition, if the antimicrobial composition is used as a pseudomonas aeruginosa proliferation suppression composition, the concentration of the lysozyme-chitosan complex is preferably 0.01% by mass or more. Moreover, if the antimicrobial composition is used as a nontuberculous mycobacteria proliferation suppression composition (pulmonary MAC proliferation suppression composition), the concentration of the lysozyme-chitosan complex is preferably 0.10 by mass or more.

This antimicrobial composition can be a cleaning liquid used in a nebulizer. Direct spraying of the antimicrobial composition onto the infected area makes it possible to suppress the proliferation of an infectious microbe.

In addition, the antimicrobial composition of the present embodiment has a proliferation suppression action against various infectious microbes which cause respiratory infectious diseases, for example nontuberculous mycobacteria such as MRSA, pseudomonas aeruginosa, and pulmonary MAC (Mycobacterium avium complex).

### EXAMPLES

Hereinafter, the present invention is described in further detail with reference to examples. The present invention is not limited only to these examples, however. Note that in the examples to be described later, the lysozyme-chitosan complex is also referred to as LYZOX (a trademark of WAKO FILTER TECHNOLOGY Co., Ltd.).

### Example 10

A proliferation suppression effect against MRSA in a diluted medium for the lysozyme-chitosan complex, lysozyme alone, chitosan alone, and the mixture of lysozyme and chitosan.

This test employed MRSA IID 1677, and this microbe strain was cultured in a normal broth medium at 37° C. for 20 hours. The cultured microbial solution was collected by centrifugation (3000 rpm, 10 minutes), suspended with sterilized water, and then diluted with sterilized water so that the optical density would satisfy OD600=1.0. The resultant was diluted 2000 times (corresponding to 10⁶ CFU/ml) to prepare a reaction microbial solution.

Each of the LB test medium samples was added with 100 μl of reaction microbial solution and was shake cultured under the condition of 37° C. for 48 hours. Here, the LB test medium samples were prepared using 10 ml of 1/2.5 LB medium added with

(1) 10 ml of sterilized water,
(2) 10 ml of the lysozyme-chitosan complex with a concentration of 0.002% (the concentration after addition was 0.001%),
(3) 10 ml of lysozyme alone with a concentration of 0.001% (the concentration after addition was 0.0005%),
(4) 10 ml of chitosan alone with a concentration of 0.001% (the concentration after addition was 0.0005%), and
(5) 10 ml of the mixture of lysozyme and chitosan with a concentration of 0.001% (the concentration of each after addition was 0.0005%).

After that, 3 ml was extracted at time intervals (0, 1, and 2 days), and the optical density was measured at an absorption wavelength of 600 nm. In addition, 100 μl was extracted when necessary and seeded on the LB agar medium, and the number of colonies produced was observed.

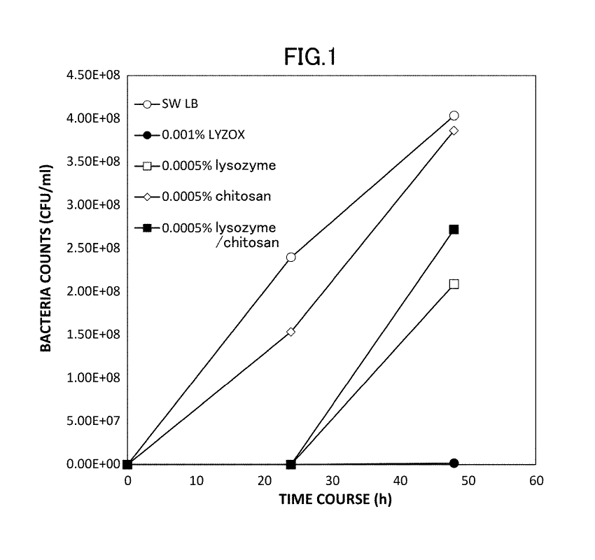

As a result of the experiment, the proliferation suppression effect against MRSA for 48 hours was observed to some extent in lysozyme alone and the mixture of lysozyme and chitosan, as shown in FIG. 1.

On the other hand, the proliferation suppression effect against MRSA for 48 hours in the lysozyme-chitosan complex showed a marked improvement effect compared to lysozyme alone and the mixture of lysozyme and chitosan.

### Example 2

A proliferation suppression effect against pseudomonas aeruginosa in a diluted medium for the lysozyme-chitosan complex, lysozyme alone, chitosan alone, and the mixture of lysozyme and chitosan.

This test employed Pseudomonas aeruginosa NBRC 13275, and this microbe strain was cultured in a normal broth medium at 37° C. for 20 hours. The cultured microbial solution was collected by centrifugation (3000 rpm, 10 minutes), suspended with sterilized water, and then diluted with sterilized water so that the optical density would satisfy OD600=1.0. The resultant was diluted 2000 times (corresponding to 10⁶ CFU/ml) to prepare a reaction microbial solution.

Each of the TSB test medium samples was added with 100 μl of reaction microbial solution and was shake cultured under the condition of 37° C. for 48 hours. Here, the TSB test medium samples were prepared using 10 ml of 1/2.5 TSB medium added with 200 μl of 1 M phosphate buffer (pH 7.0), followed by further addition of

(1) 10 ml of sterilized water,
(2) 10 ml of the lysozyme-chitosan complex with a concentration of 0.02% (the concentration after addition was 0.01%),
(3) 10 ml of lysozyme alone with a concentration of 0.01% (the concentration after addition was 0.005%),
(4) 10 ml of chitosan alone with a concentration of 0.01% (the concentration after addition was 0.005%), and
(5) 10 ml of the mixture of lysozyme and chitosan with a concentration of 0.01% (the concentration of each after addition was 0.005%).

After that, 3 ml was extracted at time intervals (0, 1, and 2 days), and the optical density was measured at an absorption wavelength of 600 nm. In addition, 100 μl was extracted when necessary and seeded on the MH agar medium, and the number of colonies produced was observed.

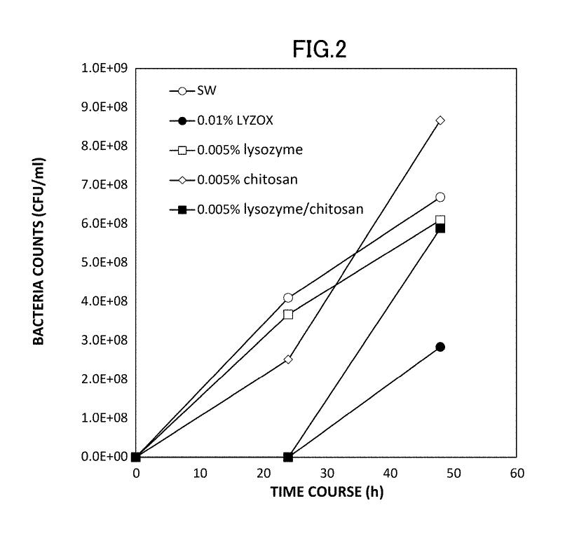

As a result of the experiment, the proliferation suppression effect against pseudomonas aeruginosa was observed in the lysozyme-chitosan complex and the mixture of lysozyme and chitosan until 24 hours, as shown in FIG. 2.

On the other hand, past 24 hours, a strong proliferation suppression effect by the lysozyme-chitosan complex was observed.

### Example 3

A proliferation suppression effect against pulmonary MAC in a diluted medium for the lysozyme-chitosan complex, lysozyme alone, chitosan alone, and the mixture of lysozyme and chitosan.

This test employed Mycobacterium avium Chester JCM15429, and this microbe strain was cultured in a Middlebrook 7H9 medium at 37° C. for 2 weeks. The cultured microbial solution was collected by centrifugation (3000 rpm, 10 minutes), suspended with sterilized water, and then diluted with sterilized water so that the optical density would satisfy OD600 =1.0. The resultant was diluted 2000 times (corresponding to 10⁶ CFU/ml) to prepare a reaction microbial solution.

Each of the Middlebrook 7H9 test medium samples was added with 100 μl of reaction microbial solution and was statically cultured under the condition of 37° C. Here, the Middlebrook 7H9 test medium samples were prepared using 10 ml of 1/2.5 Middlebrook 7H9 medium added with

(1) 10 ml of sterilized water,
(2) 10 ml of the lysozyme-chitosan complex with a concentration of 0.002% (the concentration after addition was 0.0010),
(3) 10 ml of the lysozyme-chitosan complex with a concentration of 0.02% (the concentration after addition was 0.01%),
(4) 10 ml of the lysozyme-chitosan complex with a concentration of 0.2% (the concentration after addition was 0.1%),
(5) 10 ml of lysozyme alone with a concentration of 0.1% (the concentration after addition was 0.05%),
(6) 10 ml of chitosan alone with a concentration of 0.1% (the concentration after addition was 0.05%), and
(7) 10 ml of the mixture of lysozyme and chitosan with a concentration of 0.1% (the concentration of each after addition was 0.05%).

After that, 3 ml was extracted at time intervals (0, 5, 7, and 12 days), and the optical density was measured at an absorption wavelength of 600 nm. In addition, 100 μl was extracted when necessary and seeded on the Middlebrook 7H10 agar medium, and the number of colonies produced was observed.

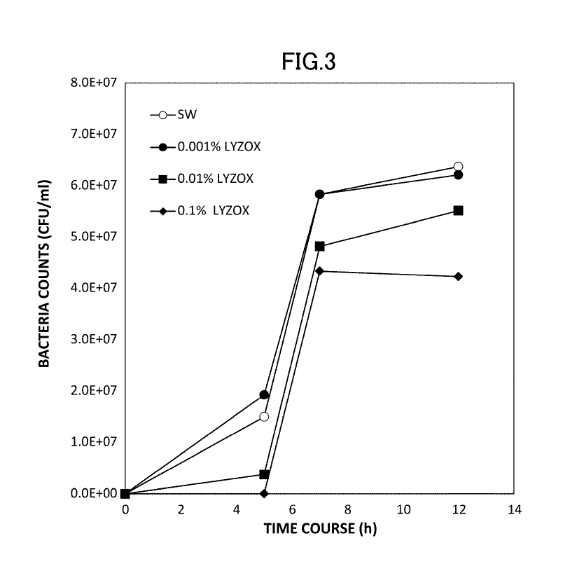

As a result of the experiment, it was confirmed that the proliferation suppression effect against pulmonary MAC increased as the concentration of the lysozyme-chitosan complex increased, as shown in FIG. 3.

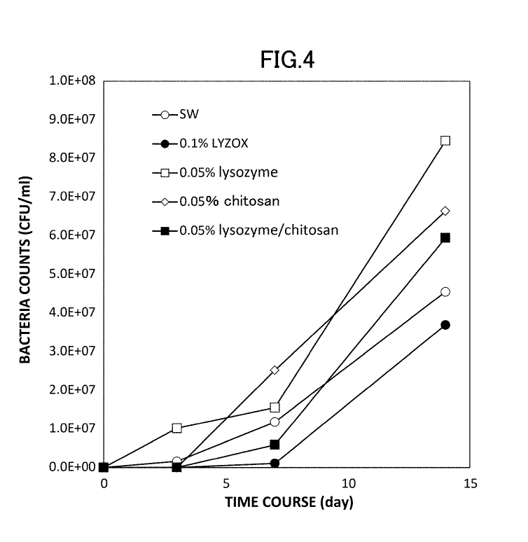

In addition, it was confirmed that the lysozyme-chitosan complex had a marked proliferation suppression effect against pulmonary MAC over 7 days compared to chitosan alone, lysozyme alone, and the mixture of lysozyme and chitosan, as shown in FIG. 4.

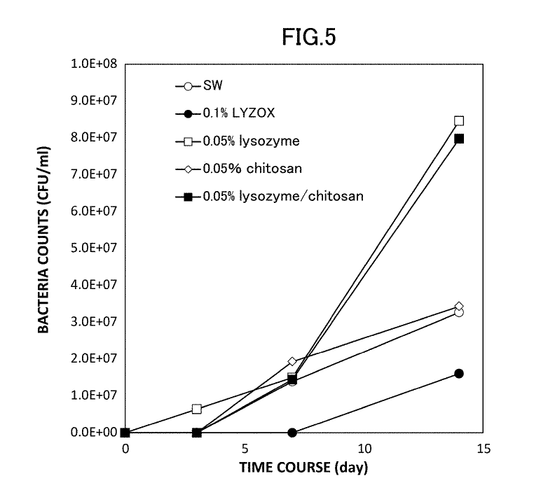

Note that FIG. 5 shows the results of using a Middlebrook 7H9 test medium sample further added with 10 mM of phosphate buffer (pH 7.0).

In this FIG. 5 as well, it was confirmed that lysozyme-chitosan complex had a marked proliferation suppression effect against pulmonary MAC over 7 days compared to chitosan alone, lysozyme alone, and the mixture of lysozyme and chitosan.

### Example 4

Heat resistance evaluation by the lysozyme-chitosan complex, lysozyme alone, and the mixture of lysozyme and chitosan.

This test is a bacteriolytic test using Micrococcus luteus bacteria being lysozyme-sensitive bacteria. Note that the bacteriolytic activity is an activity specific to lysozyme. Lysozyme is a protein relatively stable against heat. However, it is known that this activity generally decreases considerably for lysozyme heated at 80° C. for 30 minutes. This test was carried out with the aim of demonstrating that the lysozyme-chitosan complex (resultant of lysozyme bound to a chitosan oligosaccharide) gives heat resistance to the raw material lysozyme.

This test employed an aqueous solution of the lysozyme-chitosan complex with a concentration of 5%, an aqueous solution of lysozyme with a concentration of 2.5%, and an aqueous solution of the mixture of lysozyme and chitosan with a concentration of 2.50. In addition, Micrococcus luteus bacteria manufactured by Wako Pure Chemical Industries, Ltd. were used as the use bacteria.

First, 1 g of Micrococcus luteus bacteria was weighed on the day before the test, added to 100 ml of physiological saline, and stirred overnight at 4° C. Then, on the day of the test, adjustment was carried out for the Micrococcus luteus bacteria such that OD=1.00±0.05 was satisfied at a wavelength of 640 nm, and this was used as the test microbial solution. Note that the same physiological saline was used for dilution.

The solutions were prepared, and 2 ml each was placed in a 5 ml tube, followed by heat treatment in a drying furnace at 80° C. for 2 hours. Note that the same amount without heating treatment was prepared. After this heat treatment, the temperature was lowered back to room temperature, followed by incubation in a 37° C.-thermostatic chamber for 30 minutes.

In an optical density meter, 2800 μl of the test microbial solution was set to record OD (0-1) immediately before the addition of the sample. After that, 200 μl of the sample was added, followed by stirring. Since OD increased here, the highest value OD (0-2) was recorded.

Timer measurement was started after the addition of the sample to record OD at the time of 2, 4, 6, 8, and 10 minutes passed. Each test was carried out twice, and the average was calculated.

With OD for (0-2) being OD at the time of the start, Δoptical density (AOD) at each point was calculated.

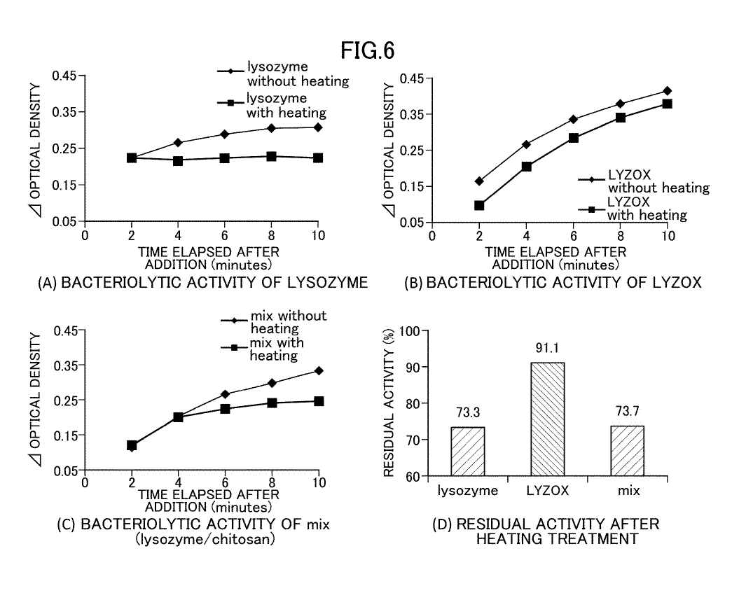

FIGS. 6(A) to (C) are each a plot of Δoptical density as the vertical axis and time as the horizontal axis for the corresponding solution. In addition, FIG. 6(D) is a comparison of Δoptical density with and without heating, showing to what extent the activity remained in the solution after heating treatment compared to the solution without heating treatment, calculated as the residual activity (following formula).

residual activity (%)=“ΔOD with heating treatment (10 minutes)”/“ΔOD without heating treatment (10 minutes)”×100

As can be seen from FIG. 6(D), the residual activity in the solution of lysozyme after heating treatment was 73.3%, whereas the residual activity in the solution of LYZOX after heating treatment was 91.9%. It is understood that a high bacteriolytic activity was achieved even after heating treatment. Therefore, the binding of lysozyme to chitosan makes it possible to enhance heat resistance compared to lysozyme alone.

### Example 5

A proliferation suppression effect against MRSA in a standard medium for the lysozyme-chitosan complex, lysozyme alone, chitosan alone, and the mixture of lysozyme and chitosan.

This test employed MRSA IID 1677, and this microbe strain was inoculated in 20 ml of a normal broth medium (manufactured by Eiken Chemical Co., Ltd., ‘Eiken’) for overnight shake culture at 37° C. The cultured microbial solution was collected by centrifugation (3000 rpm, 10 minutes), suspended with sterilized water, and then diluted with sterilized water so that the optical density would satisfy OD600=1.0. The resultant was diluted 2000 times (corresponding to 10⁶ CFU/ml) to prepare a reaction microbial solution.

Each of the TSB test medium samples was added with 100 μl of reaction microbial solution and was shake cultured under the condition of 37° C. for 48 hours. Here, the TSB test medium samples were prepared using 10 ml of TSB medium (BD BBL™) added with 200 μl of 1 M phosphate buffer (pH 7.0), followed by further addition of

(1) 10 ml of sterilized water,
(2) 10 ml of lysozyme-chitosan complex with a concentration of 0.4% (the concentration after addition was 0.2%),
(3) 10 ml of lysozyme alone with a concentration of 0.2% (the concentration after addition was 0.1%),
(4) 10 ml of chitosan alone with a concentration of 0.2% (the concentration after addition was 0.1%), and
(5) 10 ml of the mixture of lysozyme and chitosan with a concentration of 0.2% (the concentration of each after addition was 0.1%).

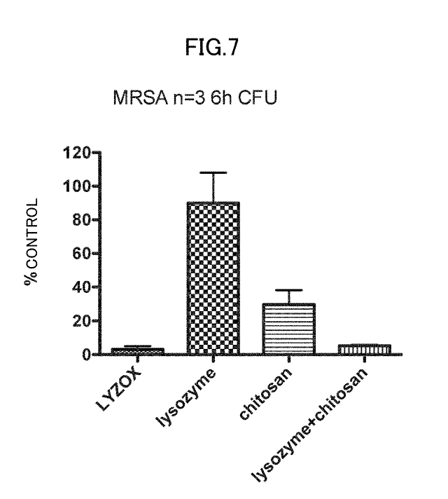

After that, 100 μl was extracted and seeded on the MH agar medium, and the number of colonies produced was observed (colony count method). FIG. 7 shows the results. FIG. 7 shows the ratio of the number of colonies produced 6 hours later for each sample to the number of colonies produced 6 hours later for the TSB test medium sample (control) which was prepared by adding 10 ml of sterilized water. Note that the results of FIG. 7 are each the average value of the values obtained by carrying out the colony count method three times.

As a result of the experiment, as can be seen from FIG. 7, almost no proliferation suppression effect against MRSA was observed in lysozyme alone, but the proliferation suppression effect against MRSA was observed in the lysozyme-chitosan complex, chitosan alone, and the mixture of lysozyme and chitosan. It was confirmed that the proliferation suppression effect against MRSA in the lysozyme-chitosan complex particularly had a marked improvement effect compared to chitosan alone and the mixture of lysozyme and chitosan.

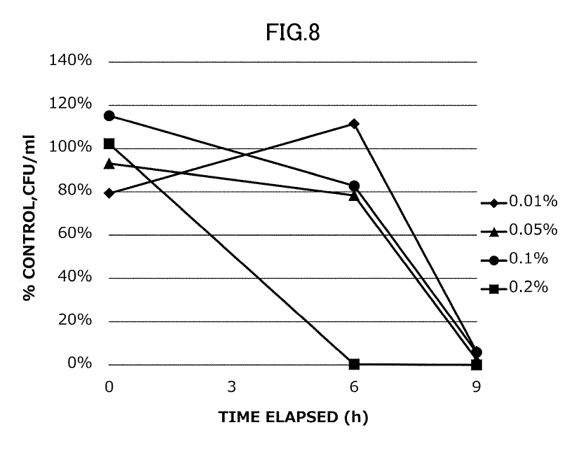

Next, the number of colonies produced was observed for each of the cases where the concentration of the lysozyme-chitosan complex after addition in the TSB test medium sample was set to 0.01%, 0.05%, 0.1%, and 0.2%. FIG. 8 shows the results. FIG. 8 shows the change in the ratio of the number of colonies produced for each concentration to the number of colonies produced for the control. Note that the results of FIG. 8 are each the average value obtained with two replicate samples.

As a result of the experiment, as can be seen from FIG. 8, a sufficient proliferation suppression effect is observed 9 hours later for any of the concentrations. In addition, 0% is almost reached past 6 hours for the lysozyme-chitosan complex with a concentration of 0.2%, showing an instant efficacy of the proliferation suppression effect.

### Example 6

A proliferation suppression effect against pseudomonas aeruginosa in a standard medium for the lysozyme-chitosan complex, lysozyme alone, chitosan alone, and the mixture of lysozyme and chitosan.

This test employed Pseudomonas aeruginosa NBRC 13275 or PAO 1, and other procedures were the same as those of [Example 5] described earlier.

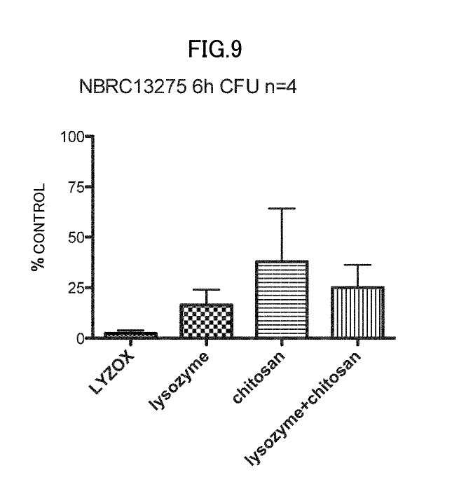

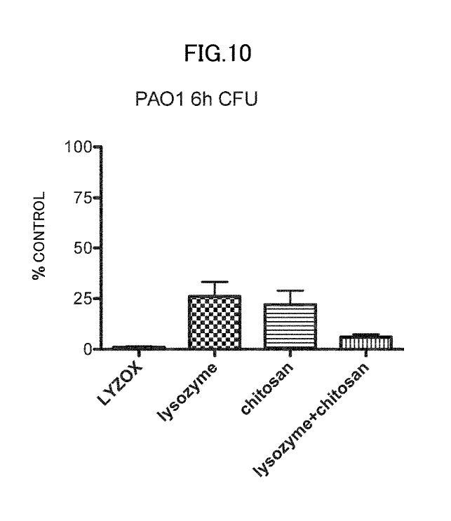

FIG. 9 shows the results for NBRC 13275 and FIG. 10 shows the results for PAO 1. Note that the results of FIG. 9 are each the average value of the values obtained by carrying out the colony count method three times and that the results of FIG. 10 are each the average value of the values obtained by carrying out the colony count method five times.

As can be seen from FIG. 9, it was confirmed that the proliferation suppression effect against NBRC 13275 for the lysozyme-chitosan complex had a marked improvement effect compared to lysozyme alone, chitosan alone, and the mixture of lysozyme and chitosan.

As can be seen from FIG. 10, it was confirmed that the proliferation suppression effect against PAO 1 for the lysozyme-chitosan complex had a marked improvement effect compared to lysozyme alone, chitosan alone, and the mixture of lysozyme and chitosan.

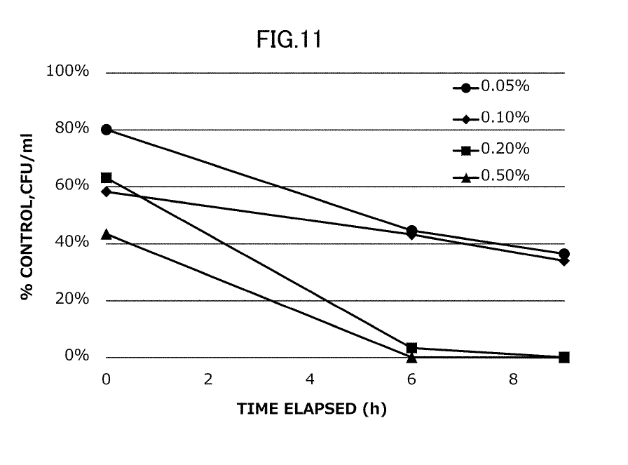

Next, the number of colonies produced was observed for each of the cases where the concentration of the lysozyme-chitosan complex after addition in the TSB test medium sample was set to 0.05%, 0.1%, 0.2%, and 0.5%. FIG. 11 shows the results. FIG. 1 shows the change in the ratio of the number of colonies produced for each concentration to the number of colonies produced for the control. Note that the results of FIG. 11 are each the average value obtained with three replicate samples.

As a result of the experiment, as can be seen from FIG. 11, 0% is almost reached 6 hours later for the lysozyme-chitosan complex with concentrations of 0.2% and 0.5%, showing a sufficient proliferation suppression effect.

### Example 7

An effect of not producing MRSA-resistant microbes for the lysozyme-chitosan complex.

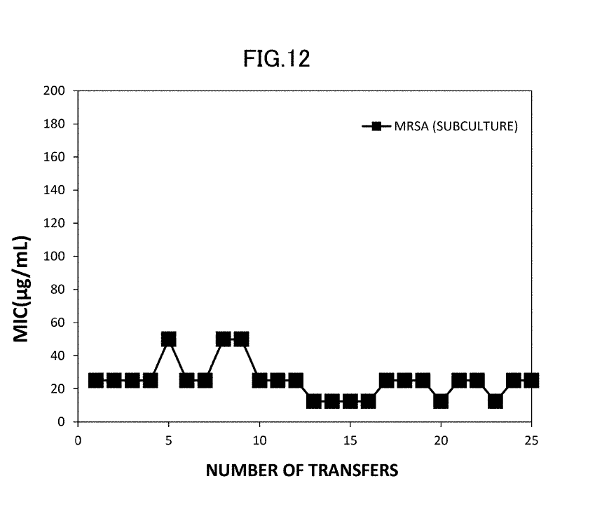

This test employed MRSA IID 1677, and a resistant microbe acquisition protocol was carried out by use of the microdilution method proposed by Japanese Society of Chemotherapy. FIG. 12 shows the results.

As can be seen from FIG. 12, even in the case of subculture using the lysozyme-chitosan complex (25 generations), the MIC (minimum inhibitory concentration) hardly changed.

On the other hand, it has been reported that a resistant microbe is observed to produce at the third generation for gentamicin, known as an antimicrobial drug against MRSA, and that a resistant microbe is observed to produce at the sixth generation for minomycin, as described in FIG. 3 of “AOKI and KASHIWAGI, ‘A study on the Significance of Strains Held in the Nasal Cavity of Health Care Workers in Nosocomial Infection of Methicillin-Resistant Staphylococcus Aureus (MRSA),’ the Journal of the Japanese Association for Infectious Diseases, Volume 64.”

### Example 8

Observation of the morphological change in MRSA by the lysozyme-chitosan complex.

First, the morphological change in MRSA was observed by using a scanning electron microscope. This observation with a scanning electron microscope was carried out as follows: osmium coating (4 nm) was performed as the conductive treatment, and a low-acceleration ultra-high resolution scanning electron microscope (SU 9000 manufactured by Hitachi High-Technologies Corporation (accelerating voltage: 1 kV)) was used. In addition, the samples were MRSA added with physiological saline and MRSA added with a lysozyme-chitosan complex with a concentration of 0.2% by mass.

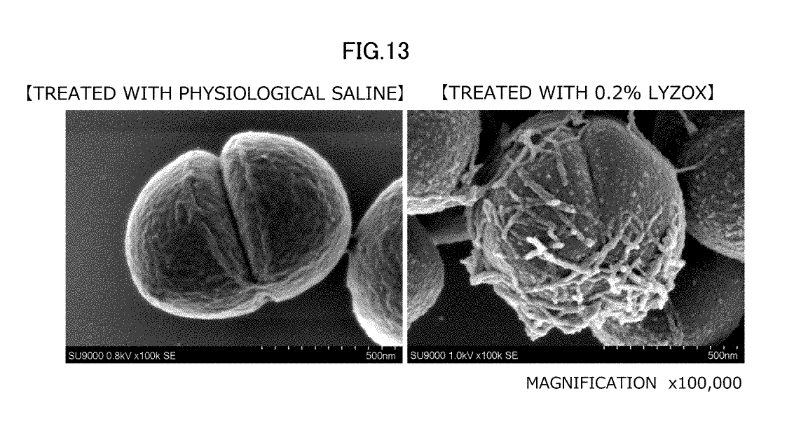

FIG. 13 shows images obtained with a scanning electron microscope. As shown in FIG. 13, MRSA does not experience a morphological change for the sample added with physiological saline, whereas fibrous adhesions have appeared on the outer surface of MRSA for the sample added with the lysozyme-chitosan complex.

Next, the morphological change in MRSA was observed by using a transmission electron microscope. This observation with a transmission electron microscope was carried out as follows: the sample was sliced in 50 nm with a diamond knife as the pretreatment and was stained with uranium acetate and lead citrate, and a transmission electron microscope (JEM-1400 manufactured by JEOL Ltd.) was used. In addition, the samples were MRSA added with physiological saline and MRSA added with a lysozyme-chitosan complex with a concentration of 0.2% by mass.

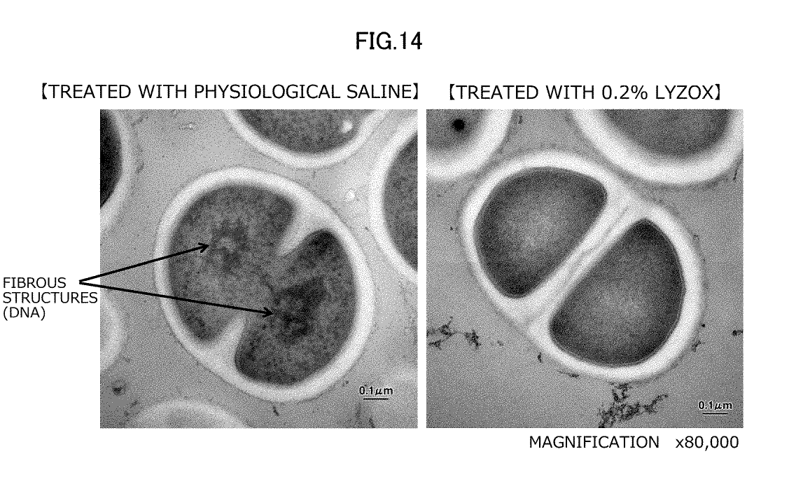

FIG. 14 shows images obtained with a transmission electron microscope. As shown in FIG. 14, MRSA does not experience a morphological change for the sample added with physiological saline, whereas fibrous structures (DNA) inside MRSA have disappeared for the sample added with the lysozyme-chitosan complex.

From these images, the lysozyme-chitosan complex is considered to destroy MRSA by acting on the cell walls of MRSA in a combined manner, one of which is antimicrobial action achieved by hydrolysis of the peptidoglycan layer or by deposition of chitosan onto cell walls due to lysozyme activity, and the other of which is surfactant action achieved by the lysozyme-chitosan hybrid. It is considered that the chromosome DNA is drawn out of the microbial body with a hole made by the lysozyme-chitosan complex, causing deposition outside the microbial body. It is considered that this makes it impossible for MRSA to proliferate, and at the same time gene loss takes away an opportunity to acquire resistant microbes.

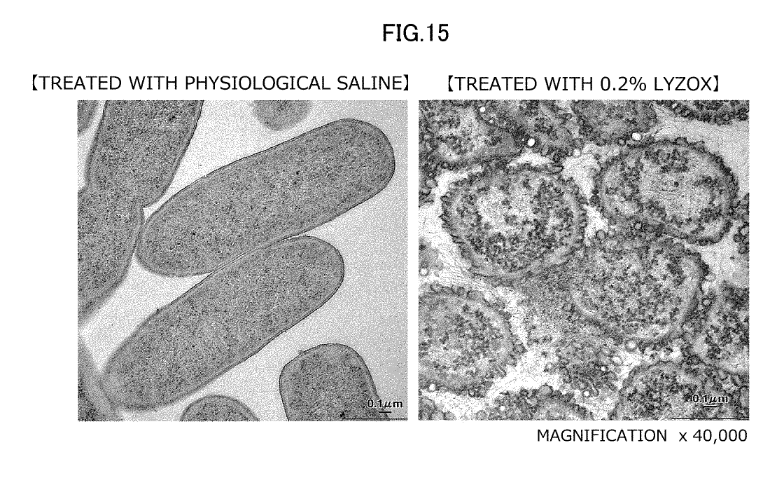

Note that the morphological change in the case of adding the lysozyme-chitosan complex to pseudomonas aeruginosa was also observed using a transmission electron microscope in the same manner as above. FIG. 15 shows the results. As can be seen from FIG. 15, addition of the lysozyme-chitosan complex to pseudomonas aeruginosa destroys the cell walls of pseudomonas aeruginosa. In other words, the lysozyme-chitosan complex also has a resistant microbe inactivation effect for pseudomonas aeruginosa.

### Example 9

Observation of morphological changes in MRSA and pseudomonas aeruginosa for the lysozyme-chitosan complex, lysozyme alone, chitosan alone, and the mixture of lysozyme and chitosan.

Observation was carried out with a scanning electron microscope for the morphological changes in MRSA and pseudomonas aeruginosa treated with the lysozyme-chitosan complex, lysozyme alone, chitosan alone, and the mixture of lysozyme and chitosan (treatment time: 2 hours). This observation with a scanning electron microscope was carried out in the same manner as Example 8 described above: osmium coating (4 nm) was performed as the conductive treatment, and a low-acceleration ultra-high resolution scanning electron microscope (SU 9000 manufactured by Hitachi High-Technologies Corporation (accelerating voltage: 1 kV)) was used. In addition, the samples were MRSA or pseudomonas aeruginosa added with physiological saline, a lysozyme-chitosan complex with a concentration of 0.1% by mass, lysozyme of 0.05% by mass, chitosan of 0.05% by mass, and a mixture of lysozyme and chitosan, each with 0.05% by mass.

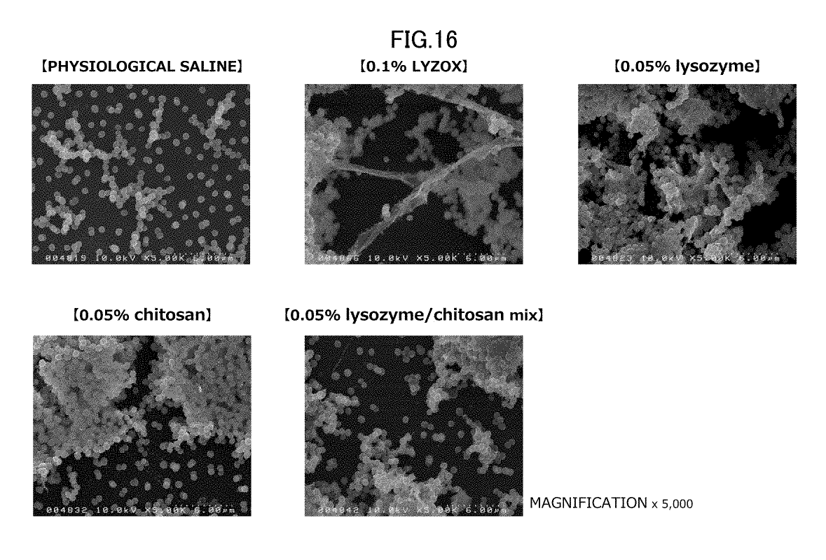

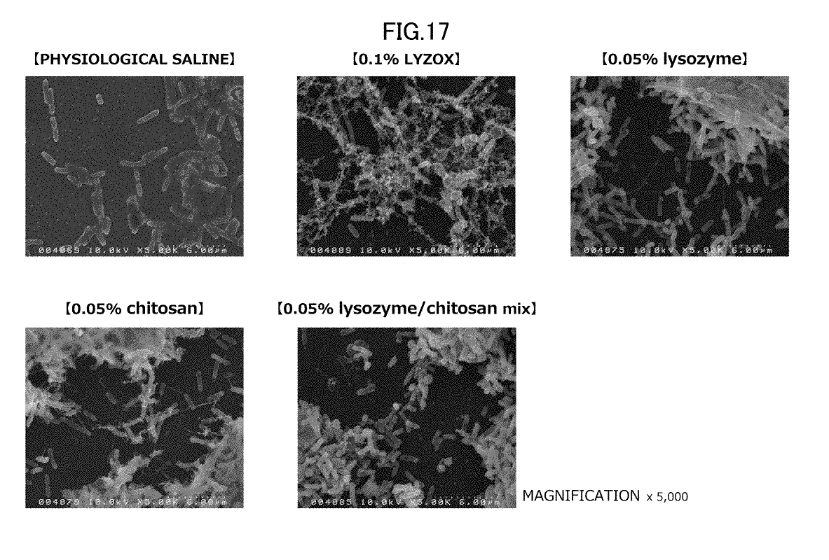

FIG. 16 shows images of MRSA and FIG. 17 shows images of pseudomonas aeruginosa, obtained with a scanning electron microscope. As shown in FIG. 16, MRSA maintains its form not only for the sample added with physiological saline but also for the sample added with lysozyme alone, the sample added with chitosan alone, and the sample added with the mixture of lysozyme and chitosan, and no significant morphological change was observed. On the other hand, the form of MRSA has changed for the sample added with the lysozyme-chitosan complex, showing a lump of fibrous adhesions appeared on the outer side thereof.

Similarly, as shown in FIG. 17, pseudomonas aeruginosa maintains its form not only for the sample added with physiological saline but also for the sample added with lysozyme alone, and no significant morphological change was observed.

In addition, although morphological change in pseudomonas aeruginosa was observed to some extent for the sample added with chitosan alone and for the sample added with the mixture of lysozyme and chitosan, most part of pseudomonas aeruginosa maintains its form. On the other hand, the form of pseudomonas aeruginosa has changed to a large extent for the sample added with the lysozyme-chitosan complex, showing a lump of fibrous adhesions appeared on the outer side thereof.

In addition, DNase I treatment was carried out for MRSA added with the lysozyme-chitosan complex and for pseudomonas aeruginosa added with the lysozyme-chitosan complex.

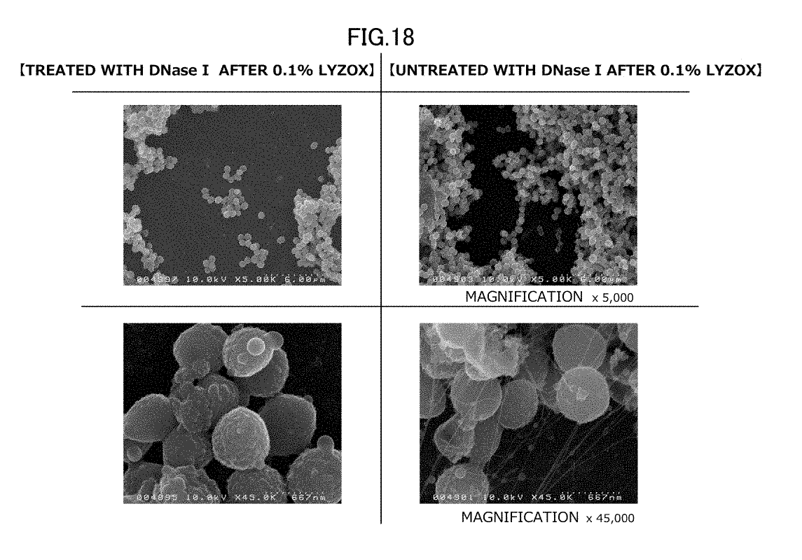

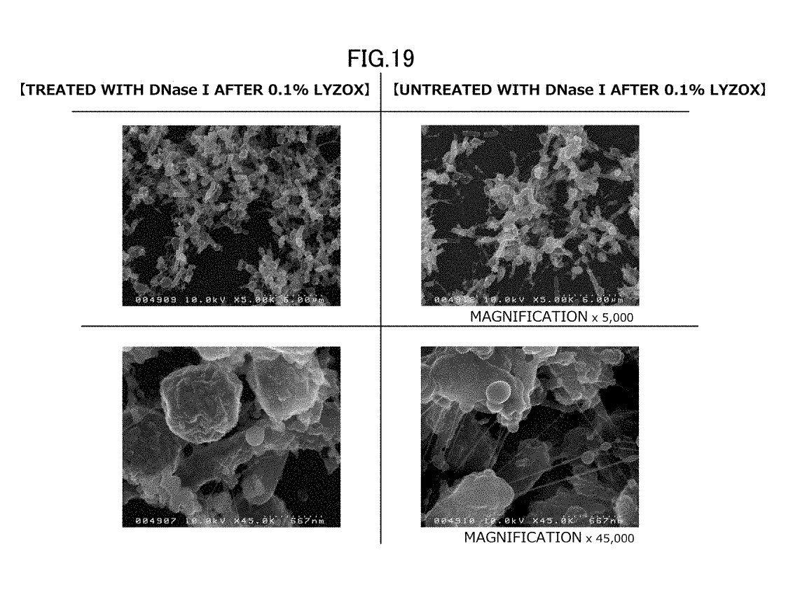

FIG. 18 shows images of MRSA obtained with a scanning electron microscope for the cases of carrying out and not carrying out DNase I treatment on MRSA added with the lysozyme-chitosan complex. In addition, FIG. 19 shows images of pseudomonas aeruginosa obtained with a scanning electron microscope for the cases of carrying out and not carrying out DNase I treatment on pseudomonas aeruginosa added with the lysozyme-chitosan complex.

In the case of carrying out DNase I treatment, the fibrous adhesions present on the outer side of MRSA and pseudomonas aeruginosa have disappeared in both of FIG. 18 and FIG. 19. To be more specific, the fibrous adhesions present on the outer side of MRSA and pseudomonas aeruginosa were revealed to be genes (DNA). As described above, it is considered that addition of the lysozyme-chitosan complex to MRSA and pseudomonas aeruginosa causes their genes to be released to the outer side, making it impossible for MRSA and pseudomonas aeruginosa to proliferate, and at the same time gene loss takes away an opportunity to acquire resistant microbes.

### INDUSTRIAL APPLICABILITY

According to the present invention, use of highly safe natural ingredients makes it possible to provide a novel antimicrobial composition against an infectious microbe which causes respiratory infectious diseases.

1. An antimicrobial composition, comprising:
a complex of lysozyme and chitosan bound to each other, wherein the antimicrobial composition has an antimicrobial property against an infectious microbe which causes respiratory infectious diseases.

2. The antimicrobial composition according to claim 1, wherein
the antimicrobial property includes a proliferation suppression action against MRSA, a proliferation suppression action against Pesuedomonas aeruginosa, or a proliferation suppression action against nontuberculous mycobacteria.

3. The antimicrobial composition according to claim 2, wherein if the antimicrobial property is the proliferation suppression action against MRSA, a concentration of the complex is 0.01% to 0.2% by weight.

4. The antimicrobial composition according to claim 2, wherein
if the antimicrobial property is the proliferation suppression action against Pesuedomonas aeruginosa, a concentration of the complex is 0.2% to 0.5% by weight.

5. The antimicrobial composition according to claim 1, having heat resistance.

6. The antimicrobial composition according to claim 1, having an action of suppressing production of a resistant microbe.

7. An aqueous antimicrobial cleaning liquid comprising the antimicrobial composition according to claim 1 and water.

8. A method for suppressing production or proliferation of a microbe, comprising:
preparing a complex of lysozyme and chitosan bound to each other, and
applying the complex to an infectious microbe which causes respiratory infectious diseases.

9. The method according to claim 8, wherein the infectious microbe is MRSA, Pseudomonas aeruginosa, or nontuberculous mycobacteria.

10. The method according to claim 8, wherein the infectious microbe is MRSA, and wherein a concentration of the complex is 0.001% by mass or more.

11. The method according to claim 8, wherein the infectious microbe is MRSA, and wherein a concentration of the complex is 0.01% to 0.2% by mass.

12. The method according to claim 8, wherein the infectious microbe is MRSA, wherein a concentration of the complex is 0.2% by mass, and wherein the application of the complex to the infectious microbe lasts 6 hours or more.

13. The method according to claim 8, wherein the infectious microbe is pseudomonas aeruginosa, and wherein a concentration of the complex is 0.01% by weight or more.

14. The method according to claim 8, wherein the infectious microbe is pseudomonas aeruginosa, wherein a concentration of the complex is 0.2% to 0.5% by weight, and wherein the application of the complex to the infectious microbe lasts 6 hours or more.

15. A method for treating or preventing respiratory infectious diseases, wherein the infectious diseases are caused by a infectious microbe, the method comprising applying a complex of lysozyme and chitosan bound to each other to the infectious microbe so as to suppress production or proliferation of the microbe.

16. The method according to claim 15, wherein the infectious microbe is MRSA, Pseudomonas aeruginosa, or nontuberculous mycobacteria.

17. The method according to claim 15, wherein the infectious microbe is MRSA, and wherein a concentration of the complex is 0.001% by weight or more.

18. The method according to claim 15, wherein the infectious microbe is MRSA, wherein a concentration of the complex is 0.2% by weight, and wherein the application of the complex to the infectious microbe lasts 6 hours or more.

19. The method according to claim 15, wherein the microbe is Pseudomonas aeruginosa, and wherein a concentration of the complex is 0.01% by weight or more.

20. The method according to claim 15, wherein the microbe is Pseudomonas aeruginosa, wherein a concentration of the complex is 0.2% to 0.5% by weight, and wherein the application of the complex to the infectious microbe lasts 6 hours or more.
